(19) United States
(12) Patent Application Publication
(10) Pub. No.: US 2025/0034026 A1
(43) Pub. Date: Jan. 30, 2025

(54) GLASS FIBER RECLAMATION SYSTEM AND METHOD

(71) Applicant: COMPOSITE RECYCLING SA, Ecublens (CH)

(72) Inventors: Pascal GALLO, Nyon (CH); Mitchell ANDERSON, Nyon (CH); Guillaume PERBEN, Nyon (CH)

(21) Appl. No.: 18/716,362

(22) PCT Filed: Dec. 6, 2022
(86) PCT No.: PCT/EP2022/084673

§ 371 Date: Jun. 4, 2024

Related U.S. Application Data
(60) Provisional application No. 63/286,263, filed on Dec. 6, 2021.

(51) Int. Cl. C03B 37/10

(52) U.S. Cl. CPC C03B 37/10

(57) ABSTRACT

Provided is a system for reclaiming glass fibers from a stock material. The system includes a chamber for holding the stock material in a low oxygen environment. and a pyrolyzer having a distributed heat source for heating the stock material. The distributed heat source uniformly heats the stock material to reduce the stock material to the glass fibers.

### TECHNICAL FIELD

The embodiments disclosed herein relate to reclaiming glass fibers from stock material, and, in particular to systems and methods for powering a pyrolyzer for reclaiming glass fibers with gases released by the pyrolyzer.

INTRODUCTION

Glass fiber reinforced plastic (GFRP) is a commonly used building material, particularly in vehicles and structures such a boats and windmills. These vehicles and structures age or fall into disuse. For example, since the late 1960s, 95% of boats under 24 meters are made of GFRP with a useful life of 30-40 years. This means over 2 decades of GFRP boats are at the end of their lifecycle and are in need of disposal. Recreation boating federations have estimated that the number of boats to be recycled in Canada alone number approximately 6 million.

The cost of disposal can be high which encourages owners to retain the

fiberglass vehicles and structures incurring storage costs. Alternatively, owners may abandon them in unsightly and/or illegal ways. Even if vehicles and structures are disposed of responsibly, disposal methods have been limited to shredding and landfilling or burning in cement kilns due to the challenges separating the resin from the glass fibers of the GFRP present. These disposal methods are both expensive and have significant environmental consequences.

Recently there has been success in using pyrolysis to separate the resin of GFRP stock material leaving behind a carbon dust and shredded glass fibers. These systems require the heat of the pyrolyzer to be evenly distributed to avoid high temperature gradients. High temperature gradients can ruin the products being reclaimed, reduce efficiency of the process, and/or cause the system to fail catastrophically. Agitation of the stock material, often by tumbling or stirring, is typically used to distribute heat from a point source through the pyrolyzer. Unfortunately, this agitation typically downgrades the quality of the glass fibers produced due to the force and friction the fibers experience and the cyclical bending of the glass fibers. There are also high costs associated with this pyrolysis method, particularly associated with the time necessary in the pyrolysis chamber.

Accordingly, there is a need for improved systems and methods for reclaiming glass fibers from a stock material particularly that better maintain the quality of the glass fibers and/or reclaims the gases released during pyrolysis and powers the pyrolyzer with the gasses.

### SUMMARY

Provided is a system for reclaiming glass fibers from a stock material. The system includes a chamber for holding the stock material in a low oxygen environment, and a pyrolyzer having a distributed heat source for heating the stock material. The distributed heat source uniformly heats the stock material to reduce the stock material to the glass fibers.

The chamber may further includes a stock material flattening apparatus for flatting the stock material during heating. The low oxygen environment volume may be reduced as the stock material is flattened. The stock material flattening apparatus may include the distributed heat source, and the distributed heat source may move with the stock material flattening apparatus.

The low oxygen environment may be induced by a vacuum.

The system may further include a reclaimer for collecting gas that is released when the stock material is heated.

The system may further include a condenser for recovering oil from the gas.

The system may further include a power system fueled by the gas, wherein the power system powers the pyrolyzer.

The system may further include a storage system for storing the gas released by the pyrolyzer.

The distributed heat source may be a gas burner.

The distributed heat source may be an electric heating element.

The system may further include a filter for removing solid particles from the gas released.

The system may further include a plurality of chambers for pyrolyzing a plurality of stock materials, and a vacuum control mechanism for controlling the low oxygen environment in one or more of the chambers independent of the low oxygen environment in another of the plurality of chambers.

The system may further include a plurality of chambers for pyrolyzing a plurality of stock materials and a temperature control mechanism for controlling the temperature in one or more of the chambers independent of the temperature in another of the plurality of chambers.

Provided is a method for reclaiming glass fibers a stock material. The method includes holding the stock material in a low oxygen environment, uniformly heating the stock material in the low oxygen environment, and reducing the stock material to the glass fibers

The method may further include collecting gas that is released when the stock material is heated.

The method may further include powering the pyrolyzer with the gas to heat to the stock material.

The method may further include condensing the gas to recover oil released from the stock material.

The method may further include independently controlling one or more of the temperature and the oxygen level of one or more chambers.

The method may further include flattening the stock material during heating.

The method may further include affixing the stock material to a static surface during pyrolysis.

The method may further include heating the glass fibers in an atmosphere environment and removing a carbon coating from the glass fibers.

The method may further include applying a surface treatment to the glass fibers to reduce the friction coefficient on a surface of the glass fibers.

The method may further include tumbling the glass fibers to randomize the orientation of the glass fibers.

### BRIEF DESCRIPTION OF THE DRAWINGS

The drawings included herewith are for illustrating various examples of articles, methods, and apparatuses of the present specification. In the drawings:

FIG. 1 is a block diagram of a pyrolysis system, according to an embodiment;

FIG. 2 is a diagram of the pyrolysis system of FIG. 1, in accordance with an embodiment;

FIG. 3 is a diagram of the pyrolysis system of FIG. 1, in accordance with an embodiment;

FIG. 4 is a perspective view schematic of the pyrolysis system of FIG. 1, in accordance with an embodiment;

FIG. 5 is a side view schematic of the pyrolyzer of FIG. 4 in an open configuration, in accordance with an embodiment;

FIG. 6 is a cross sectional side view of the pyrolyzer of FIG. 5 in a closed configuration, in accordance with an embodiment;

FIGS. 7A and 7B are cross-sectional block diagrams of a flattening apparatus, in accordance with an embodiment;

FIG. 8A and 8B are photographs of stock materials, in accordance with an embodiment;

FIG. 9 is a photograph of glass fibers after pyrolysis, in accordance with an embodiment;

FIG. 10 is a photograph of glass fibers after pyrolysis, in accordance with an embodiment; and

FIG. 11 is a flow chart of a method for reclaiming glass fibers, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

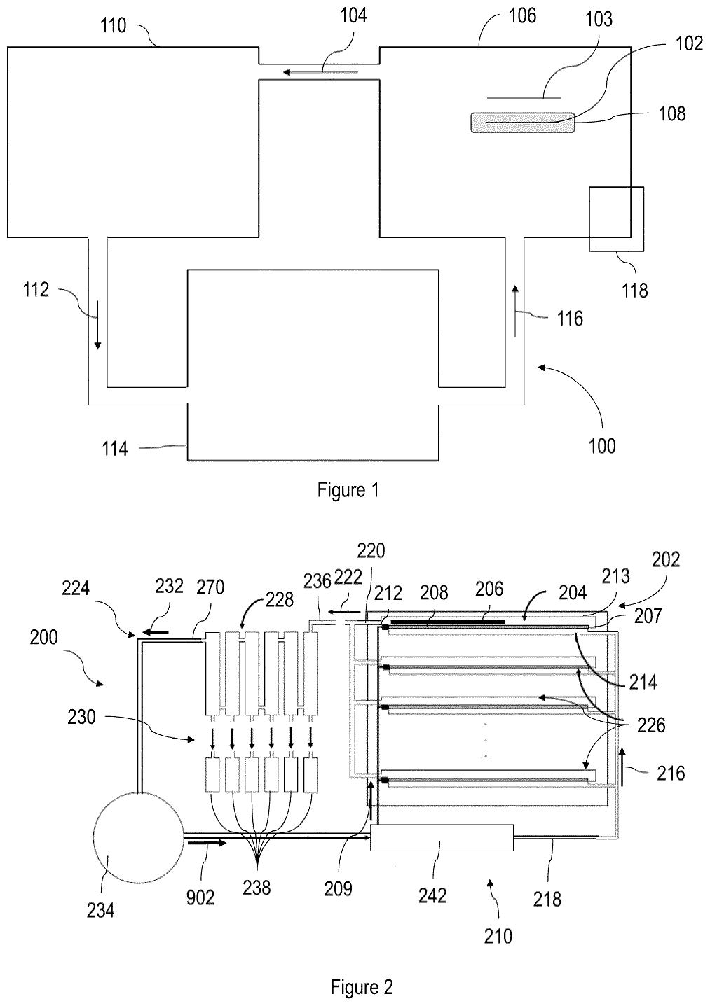

Referring to FIG. 1, illustrated therein is a pyrolysis system 100 for reclaiming glass fibers from a stock material 102, according to an embodiment.

The stock material 102 may be any material that, when heated in a pyrolyzer 106, separates into gases 104 and a solid remnant. The stock material 102 may be a GFRP that, once heated in a pyrolyzer 106, leaves a solid remnant including glass fibers. The stock material 102 may include one or more of GFRPs in a sandwich structure or a glass fiber/polymer composite. These GFRPs are typical building materials for boats and windmills many of which are in need of an environment and cost effective disposal/recycling solution.

The pyrolysis system 100 includes the pyrolyzer 106. The pyrolyzer 106 is configured to heat the stock 102 material such that the stock material 102 separates into a solid remnant and gases 104. The stock material 102 may be restricted based on the pyrolyzer 106 size.

The pyrolysis system 100 includes a chamber 108 that holds the stock material 102 in a low oxygen environment. The pyrolysis system 100 includes a pyrolyzer 106 that has a distributed heat source 103 for heating the stock material 102. The distributed heat source 103 uniformly heats the stock material 102 to reduce the stock material 102 to the glass fibers.

The distributed heat source 103 provides a uniform heat across the length of the stock material 103. The chamber 108 holds the stock material 102 so that the stock material 102 received heat that is evenly distributed across the distributed heat source 103 so that there is not a concentration of heat in one area of the chamber 108 or on the stock material 102. The shape of the distributed heat source 103 corresponds to the shape of the stock material 102 and/or the shape of the chamber. For example, where the stock material 102 is elongated and relatively flat, the chamber 108 will be elongate and flat while the distributed heating element 103 will also be elongate and flat.

The pyrolyzer 106 may include multiple chambers 108. Each chamber 108 may be on a level of the pyrolyzer 106 with other chambers. In an embodiment, the heat provided to each level of chambers is controlled individually. This individual control provides individually controlled heat zones. This maximizes the payload by providing multiple levels for pyrolysis of the stock material 102.

The Pyrolyzer 106 may include expansion joints. The expansion joints are fitted to relive thermal elongation stress from the pipe system.

During pyrolysis, an oxygen control system 118 provides and maintains the low oxygen environment in the chamber 108. The low oxygen environment prevents combustion of the stock material 102 during pyrolysis causing elements of the stock material 102 to vaporize without burning. The oxygen control system 118 may provide and maintain this low oxygen environment by creating one or more environmental conditions including a vacuum or a neutral atmosphere. Where the low oxygen environment is achieved via a vacuum the oxygen control system 118 provides a pressure of 10 mbar or less. Where the low oxygen environment is achieved via a neutral atmosphere, the oxygen control system 118 evacuates the oxygen in the chamber 106 by providing a neutral gas to replace the oxygen. This neutral gas may include nitrogen. The neutral gas may be provided by a pipe feedthrough. The pipe feed through may be a DN 20 ISO mm pipe feedthrough.

The chamber 108 may be sealed with a dual seal system for preventing the leakage of air (Oxygen) into the system. Less air leakage provides a higher quality pyrolysis and minimizes the risk of fire and/or explosions.

The chamber 108 may further include a leakage detection system. The leakage detection system may warn an operator in the case of leak. The leakage detection system may also control the pyrolyzer to avoid issues such as fire and/or explosion in the event of the leak. The control may include stopping the heat source of the pyrolyzer 106.

The pyrolyzer 106 may further include an explosion hatch. The explosion hatch is designed to be the weak link in the event of an explosion. The explosion hatch may be positioned on the top, bottom or both of the pyrolyzer. The explosion hatch may include connecting bolts. The connecting bolts connect the explosion hatch to the pyrolyzer 106. In the event of an explosion, the connecting bolts may be deformed and/or dislocated. The deformation/dislocation acts as a pressure release valve in the unlikely event of an explosion.

The pyrolysis system 100 reclaims gases 104 released during pyrolysis to provide power for the pyrolyzer 106. The gases 104 are released from the pyrolyzer 106 to a reclaimer 110 which collects the gases 104. The reclaimer 110 may further process them for into fuel 112 for a power system 114.

The power system 114 converts the fuel 112 to a power source 116 of the pyrolyzer 106. The power system 114 directs the power source 116 to the pyrolyzer 106. In some configurations, components of the power system 114 may be contained within the pyrolyzer 106.

The pyrolyzer produces gases 104 during pyrolysis process when the resin of the stock material 102 is separated from the glass fibers. During pyrolysis, elements of the resin are vaporized by the heat provided by the distributed heat source 103 to the pyrolyzer 106 by the power system 114. The operating temperatures of the pyrolysis range between 300° C. and 700° C. In an embodiment a nominal working operation temperature of 550° C. maintained. The pyrolyzer 106 may further heat the stock material 102 for a process time of four hours. The process time may include a ramp up time of 40 minutes wherein the temperature of the stock material 102 is gradually increased. The heating power may be calculated to be a minimum of 100 KW. At this heating power the temperature my raise 500 kg of GFPR from 400° C. to the nominal temperature in 40 minutes. The remaining three hours and 20 minutes are commonly referred to as the treat time. The elements of the resin that are produced during vaporization and their ratio in the composition of the gases 104 are dependent on the temperature maintained in the chamber 108 by the distributed heat source 103 during pyrolysis.

Higher temperatures may produce shorter and more desirable molecules. For example, higher temperatures will produce a higher ratio of non-condensable gases such as H₂, CH₄, and C₂H₆ molecules C₃ containing molecules such as propane, and C₄ containing molecules such as butane and a lower ratio of CO, CO₂. Higher temperatures will also produce a higher ratio of gases condensable into a liquid phase such as benzene, toluene, styrene, and ethylbenzene. The higher temperature maintained in the chamber 108, however, the higher the power consumption of the pyrolyzer 106. The power consumed by the pyrolyzer 106 is therefore balanced with the usefulness and desirability of the produced elements both as fuel 112 for the power system 114 and the market rate for other elements.

Referring now to FIG. 2 shown therein is a cross sectional schematic diagram of an electric pyrolysis system 200, according to an embodiment, of the pyrolysis system 100 of FIG. 1.

The pyrolyzer 202 of the electric pyrolysis system 200 includes a first chamber 204 into which stock material 206 is placed. The height of the first chamber 204 may be constructed to maximize the height of the stock material 206 that may be accommodated without significantly sacrificing efficiency or risking exposing the first chamber 204 to a thermal gradient that will promote failure of the pyrolyzer 202.

In an embodiment, the first chamber 204 is oriented horizontally and the stock material 206 lies on a bottom surface 207 of the first chamber 204. In another embodiment, the first chamber 204 is oriented vertically such that the stock material 206 hangs within the first chamber 204 by a hanging fixture.

The first chamber 204 includes an electrical heating element (as an example of the distributed heating element 103 of FIG. 1) for providing uniform heat to the first chamber 204. The heating element 208 may include an electrical resistance element to convert electric power 209 to heat for the first chamber 204. The resistance element may be a resistance wire. The resistance wire may be embedded through the heating element 208 in a pattern that is even and closely packed. This pattern provides heat which is dispersed homogenously across the heating element 208. This dispersal of heat minimizes the thermal gradient across the first chamber 204 to improve efficiency and allow for the pyrolyzing of the stock material 206 while reducing the risks to the pyrolyzer caused by a thermal gradient.

The electrical heating element 208 is powered with electric power provided by the power system 210 via a wire 212. In an embodiment, the heating element 208 is located at the bottom surface 207 of the first chamber 204. In a further embodiment, the heating element 208 is located at a top surface 213 of the first chamber 204. In a further embodiment, the heating element 208 is located both at the bottom surface 207 and the top surface 213 of the first chamber 204.

The first chamber 204 further includes a heat exchange element 214 for providing heat to the first chamber 204. The heat exchange element 214 is provided with heat by the of exhaust fumes 216 of the power system 210 through a power system exhaust pipe 218. In an embodiment, the heat exchange element 214 is located at the bottom of the first chamber 204. In a further embodiment, the heat exchange element 214 is located at a top surface 213 of the first chamber 204. In a further embodiment, the heat exchange element 214 is located both at the bottom surface 207 and the top surface 213 of the first chamber 204.

The first chamber 204 includes a vent 220 through which the gases 222 exit the first chamber 204 and are released to the reclaimer 224. The vent 220 is a one-way valve that maintains the low oxygen environment in the first chamber 204.

The pyrolyzer 202 may include additional chambers 226 similarly configured for processing multiple stock materials concurrently. The additional chambers 226 may be arranged inside the pyrolyzer 202 and the first chamber 204 and/or the additional chambers 226 benefit from the heat provided to the other chambers. This arrangement can reduce the temperature gradient in each of the first chamber 204 and/or the additional chambers 226.

The reclaimer 224 includes a condenser 228 for separating oil 230 from non-condensable gas 232 present in the gases 222 released from the pyrolyzer 202 and a storage vessel 234 for containing the non-condensable gas 232. The condenser 228 receives the gases 222 from the pyrolyzer 202 through a condenser inlet 236. The gases 222 pass through the condenser 228 which may be cooled with water circulated through a chiller. The gases 222 are condensed as the gases 222 pass through the condenser 228. Condensing the gases 222 separates the gases 222 into condensed oil 230, which is condensed into a liquid phase, and non-condensable gas 232. The condenser may be open at the top and/or include a drain at the bottom for ease of cleaning.

The condensed oil 230 drops into oil containers 238 at the base of the condenser 228. The oil 230 collected is now available for uses in external applications such as fuel, or precursors for chemical compounds based on molecules present in the oil such as plastics. The oil containers 238 may contain distribution pumps for pumping the oil to their intended use. The distribution pumps may further include level and temperature indicators. The remaining non-condensable gas 232 is released from the condenser 228 through a condenser outlet 240 where it is received by the storage vessel 234. The storage vessel 234 stores the non-condensable gas 232 until required by the power system. The storage vessel 234 may include ventilation to atmosphere.

The power system 210 includes a gas generator 242 that runs by burning the non-condensable gas 232 thereby generating electric power 209. The electrical power 209 powers an electric heating element 208 for providing heat for the pyrolyzer 202. The electrical power 209 provided to the electric heating element 208 may be controlled by a control system for controlling the heat provided to each of the first chamber 204 and/or additional chambers 226 together and/or independently.

A byproduct of the operation of the gas generator 242 is hot gas exhaust 216 which is piped into a heat exchanger 214 which may also provide heat for the pyrolyzer 202. The hot gas exhaust 216 provided to the heat exchanger 214 may be controlled by a control system for controlling the heat provided to each of the first chamber 204 and/or additional chambers 226 together and/or independently.

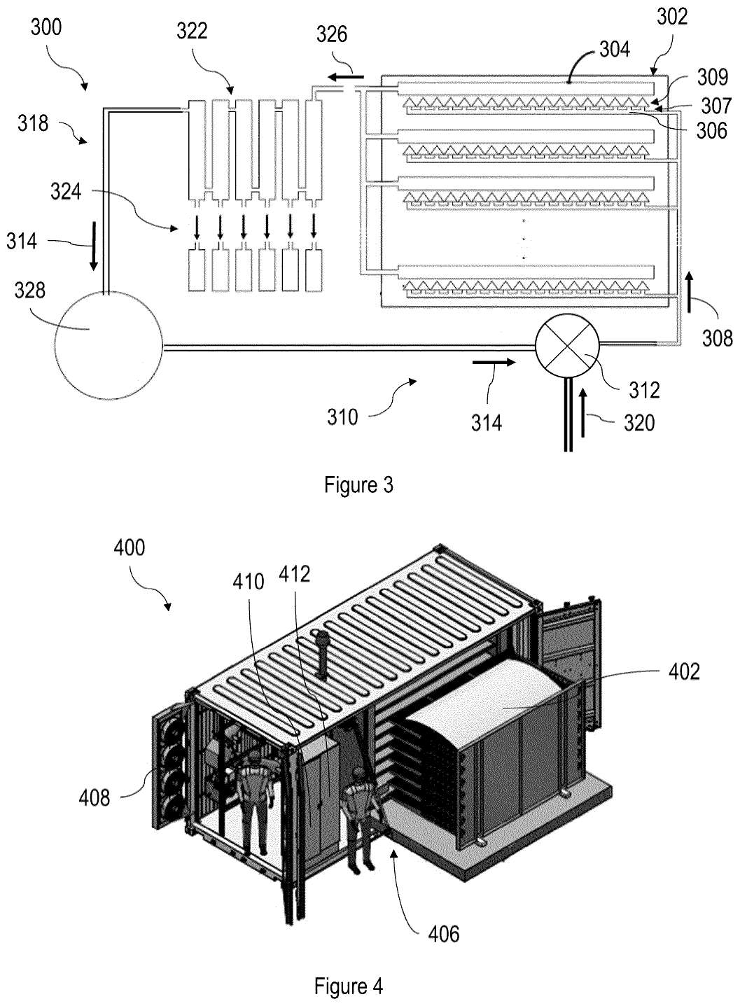

Referring now to FIG. 3 shown therein is a cross sectional schematic diagram of a gas burner pyrolysis system 300, according to an embodiment.

The pyrolyzer 302 provides uniform heat to the chambers 304 by gas burners 306 (an example of the distributed heating element 103 of FIG. 1). The gas burners 306 include outlets 307 which disperse the gas mixture 308 supplied to the gas burners 306. The outlets 307 may be spaced evenly and closely packed such that when the burner is lit, the flames 309 provide heat to the chambers 304 which is dispersed homogenously across the gas burners 306.

The gas burners 306 are fueled by a gas mixture 308 provided by the power system 310. The power system 310 includes an inlet 312 that receives the non-condensable gas 314 from the reclaimer 318 and external gases 320, such as oxygen. The inlet 312 regulates the mixture of the non-condensable gas 314 and the external gases 320 creating a gas mixture 308. The inlet further regulates the flow rate of the gas mixture 308 to one or more gas burners 306. In a further embodiment, a distribution valve may regulate flow rate to the gas burners 304 independently or in groups. The distribution valve may be part of a control system that regulates the temperature in chambers 304.

The reclaimer 318 includes a condenser 322 that separates oil 324 and the non-condensable gas 314 of gases 326 released by the pyrolyzer 302. The reclaimer 318 also includes a storage tank 328 that receives the non-condensable gas 314 from the condenser 322 and stores it until it is released to the power system 310.

Referring now to FIG. 4, shown therein is a perspective view schematic of a pyrolysis system 400, according to an embodiment. The pyrolysis system 400 may be the pyrolysis system 100 of FIG. 1.

The pyrolysis system 400 is configured to fit inside a (e.g., 20 ft, high cube open side) shipping container. In this embodiment, the stock material 402 may be up to one or more of 1.5 m wide, 2.5 m long and 15 cm high. The height of the stock material 402 is due predominately to a curvature of the stock material 402. The pyrolyzer 406 has a load capacity of 500 kg of stock material 402 per each batch.

The pyrolysis system 400 may further include an air cooling system 408. The air cooling system 408 provides cooling for heat exchangers of the pyrolyzer 406. The air cooling system 408 may be rotatably connected to a door of the pyrolysis system 400.

The pyrolysis system 400 may be composed of corrosion resistant stainless steel. The material of the pyrolysis system 400 is a suitable high temperature class such as MA 253 (EN 1.4835).

The pyrolysis system 400 may further include a power cabinet 410. The pyrolysis system 400 is connected to the power system through the power cabinet 410. The power cabinet 410 may be powered with 250 Amp 400 Volt 3 phase power. The power cabinet 410 may be fused to cope with the estimated power of the oven such as 125 KW. The power cabinet 410 may include a human machine interface (HMI) panel. The HMI panel may be a 10″ panel. The HMI panel may be mounted on a door of the power cabinet 410. The power cabinet 410 may be configured to provide 220 VAC AC for powering components of the pyrolysis system 400 such as lighting and power sockets for convenience.

The pyrolysis system 400 may further include a control system cabinet 412. The control system cabinet 412 may be the same cabinet as the power system cabinet 410. The control system cabinet 412 includes cables for logics and sensors of the pyrolysis system 400. The control system cabinet 412 may include an HMI panel for the control system. The control system cabinet 412 further includes a radio control. The radio control transmits information collected by sensors of the pyrolysis system such as control display, oven operation information, temperature in the chambers, time to finish, alarms, etc. The radio control may transmit the information to local displays (within the pyrolysis system 400) or externally. The radio control may transmit to one or more of forklift trucks and a site office. The radio control may have a free outdoor range of approximately 1 km. The information may be provided by the radio control to a cloud server. The cloud server may store and secure the information. The cloud server may have a web interface to access the information. The web interface may require authentication of a security clearance or security clearance level to access the information. The control system cabinet 412 may include an internet connection. The internet connection may be used for service calls. The internet connection may be configured to provide updates to programmable logic controllers of the pyrolysis system 400. The internet connection may be one or more of 4^{th} generation and 5^{th} generation cellular service (and generations beyond). The control system cabinet may further include a global positioning system (GPS) tracker.

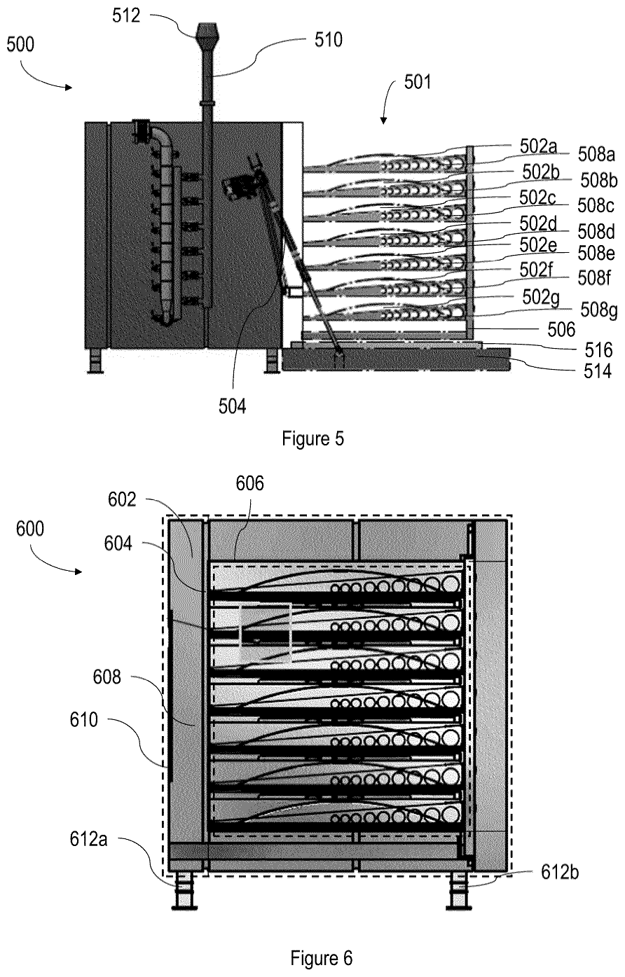

Referring now to FIG. 5, shown therein is side view schematic of a pyrolyzer 500 in an open configuration, according to an embodiment. The pyrolyzer 500, may be the pyrolyzer 106 of FIG. 1.

The pyrolyzer 500 includes a rack system 501. The rack system 501 provides the stock material 502a-g to chambers such as chambers 108 of FIG. 1. The stock material 502a-g are referred to generically as stock material 502 and collectively as stock materials 502. The rack system 501 allows the stock materials 502 to be slid, rolled, loaded, and/or inserted into the oven in a swift and safe manner. The rack system 501 may be loaded with the stock materials 502 by one or more of a crane, a fork lift truck (FLT) and manual loading.

The rack system 501 may be spring loaded to compress gently against the hot shelves of the pyrolyzer when the oven is closed. The rack system 501 may be composed of stainless steel. The stainless steel may be of a 316-L quality. The rack system 501 may include wheels for moving the rack system 501 in and out of the oven. In an embodiment brass or copper bushing are used for the wheels.

The rack system 501 includes a rack frame 506. The rack frame 506 provides the structure for the rack system 501. The rack frame is connected to the wheels.

The rack system 501 includes at least one of racks 508a-g. The racks 508a-g are referred to generically as rack 508 and collectively as racks 508. The rack 508 may be referred to as a shelve. The rack 508 is connected to the rack frame 506 such that when the rack frame 506 is inserted into the oven, the rack 508 is positioned in chamber of the pyrolyzer.

The connection of the rack 508 to the rack frame 506 may be detachable such that the rack 512 may be removed and replaced. The replacement rack may be the rack 508 (i.e. after unloading) or a second rack 508. For example, there may be at least two set of racks 508. The two sets of racks 508 allow one set to cool down, discharge and/or charge while the other is in operation. In an embodiment, the rack system 501 includes a rack 508 for each chamber of the pyrolyzer 500. It is not necessary that a full set of racks 508 be attached to the rack frame 506 for the pyrolyzer 500 to be in operation.

The pyrolyzer 500 includes an exhaust gas feedthrough 510. The exhaust gas feedthrough 510 may terminate at an upper end in a funnel 512. The exhaust gas feedthrough 510 may be positioned at a back or side of the pyrolyzer 106 of FIG. 1. The exhaust gas feedthrough 510 may include one or more of a valve, pressure detection sensor and gas flow meter. These slow the gas leaving that oven as long as possible maximizing gas reaction and creation of gas spices.

The pyrolyzer 500 further includes a door 514. The door 514 is rotatably connected to the pyrolyzer 500 at a bottom edge 516. The door 514 may rotate about the bottom edge such that when the pyrolyzer is in an open configuration, the door contacts a floor surface 516. When the door 514 is in the open configuration, it may provide a stable surface for the rack system 501 to roll or slide on.

The door 514 may include rails 516. The rails 516 are configured to receive and guide the wheels of the rack system.

The pyrolyzer 500 further includes at least one electric cylinder 518. The electric cylinder 518 transitions the door 514 between an open and closed configuration. The electric cylinder 518 is connected to side surface 520 of the pyrolyzer and a side surface of the door 520.

Referring now to FIG. 6, shown therein is a cross-sectional schematic view of a pyrolyzer 600 in a closed configuration, according to an embodiment. The pyrolyzer 600 may be the pyrolyzer 106 of FIG. 1.

The pyrolyzer 600 may be insulated. The insulation 602 may surround the pyrolyzer 600. The insulation 602 is of a thickness to allow safe operation of the pyrolyzer 600 according to standards.

The insulation 602 may include multiple layers. The insulation 602 may include an inner layer 604 adjacent to an internal surface 606 of the pyrolyzer 600. The inner layer 604 may be of a high temperature material such as ceramic or glass. The insulation 602 may further include a middle layer 608. The middle layer 608 is positioned outside the inner layer 604. The middle layer 608 may be of stone, wool or similar materials. The insulation 602 may further include an outer layer 610. The outer layer 610 is positioned outside of the inner layer 604 and/or the middle layer 608. The outer layer 610 may be of a material according to class standards ˜55° C.

The bottom of the pyrolyzer 600 may include slanted sides. The slanted sides may be slanted towards a valve for allowing cleaning of soot, ash, dust, or other particles. The bottom valve may have a redundant closing system.

The pyrolyzer 106 may further include one or more scales 612a,b. The scales 612a,b may measure one or more of the weight of treated raw material and accumulated and/or stored volume of pyrolysis oil collected from the system. The scales 612a,b may be positioned under the pyrolyzer 600. The scales 612a,b may be positioned under feet of the pyrolyzer 600. In a further embodiment, legs of the pyrolyzer may include load cells that serve as scales 612a,b.

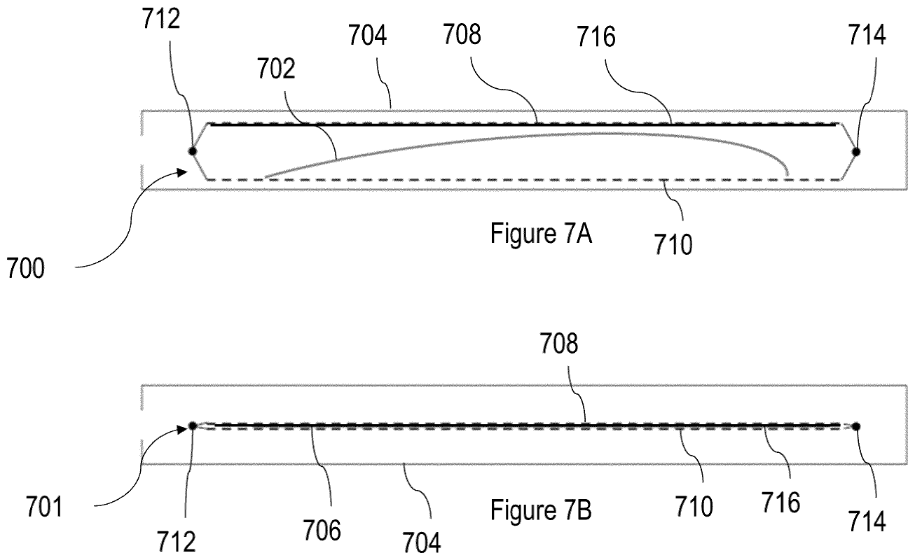

Referring now to FIGS. 7A and 7B, shown therein are cross-sectional block diagram of a flattening apparatus in a first position 700 and a second position 701 respectively. When the stock material 702 is placed in a pyrolyzer chamber 704 without a flattening apparatus, the stock material 702 will typically will not lie flat on the bottom of the chamber 704. As pyrolysis progresses and the stock material 702 softens, the stock material 702 will collapse under its own weight. Often this collapse causes the stock material 702 to fold on top of itself degrading the quality, uniformity, and configuration of the resulting glass fibers 706.

The flattening apparatus 700, 701 flattens the stock material 702 between an upper plate 708 and a lower plate 710 during pyrolysis. The flattening apparatus 700 promotes the production of uniform, straight, and high-quality glass fibers 706.

The lower plate 710 may be static. The lower plate 710 may be the bottom of the chamber 704.

The flattening apparatus 700 includes a first hinge 712 and a second hinge 714 that join a first and second side, respectively, of the upper plate 708 and lower plate 710. The first hinge 712 and the second hinge 714 are on opposite sides of the upper plate 708 and lower plate 710. As pyrolysis progresses, the first hinge 712 and second hinge 714 close bringing the upper plate 708 and lower plate 710 together. The closure of the first hinge 712 and second hinge 714 may be passive in that it is caused by the weight of the upper plate 708. Alternatively, the first hinge 712 may be driven by a spring or motor actuator to facilitate closure. The flattening apparatus 700 may include additional hinges which join one or more of the first side, second side or other sides of the upper plate 708 and lower plate 710, respectively,

The upper plate 708 and/or lower plate 710 may be made of materials such as metal that promote the even distribution of heat across the stock material 702 and/or that heat up via of induction heating elements. As such, the flattening apparatus 700 may also facilitate more efficient heating.

The upper plate 708 and/or lower plate 710 may also include heating elements 716, such as heating element 208 of FIG. 2. The heating element 716 maintains a more consistent separation from the stock material 702 than the static heating element 208 of FIG. 2 as it flattens. Maintaining a consistent separation from the stock material 702 reduces the temperature needed to produce the same result as heating the space required by the original form of the stock material 702 throughout the pyrolysis. It is further desirable to maintain the minimum amount of separation possible between the upper plate 708 and/or lower plate 710 and the stock material 702. This consistent and minimal separation in turn may reduce the power required by the pyrolyzer 202 of FIG. 2 thereby increasing efficiency.

The flattening apparatus 700 may be configured to be stackable with other flattening apparatus. The flattening apparatus may further be configured to minimize the volume occupied when the flattening apparatus 700 is empty. The flattening apparatus being stackable and minimizing volume will minimize volume the flattening apparatus 700 occupies during shipping.

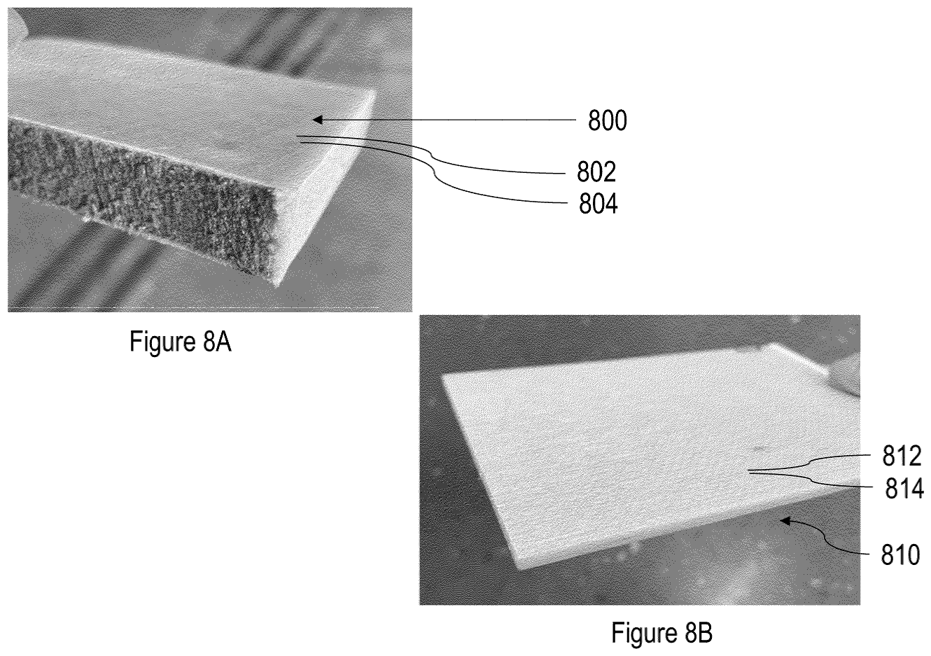

Referring now to FIGS. 8A shown therein is a photograph of stock material in a sandwich structure 800, according to an embodiment. This stock material 800 is used in constructing, among other things, water vehicle hulls many of which have recently reached or are nearing the end of their useable lifecycle. These hulls provide an ample source of stock material in a sandwich structure 800. The stock material in a sandwich structure 800 includes glass fibers 802 and a resin 804 which are separated by heating in the pyrolyzer 106 of FIG. 1.

Referring now to FIG. 8B shown therein is a photograph of a standard glass fiber/polymer stock material 810, according to an embodiment. This glass fiber/polymer stock material 810 is used in constructing, among other things, windmill blades. These windmill blades each of which consist of a significant amount of material and present a significant disposal cost and challenge at the end of their useable lifecycle. Their size provides an ample source of glass fiber/polymer stock material 810 typically at one site. The glass fiber/polymer stock material 810 includes glass fibers 812 and a resin 814 which are separated by heating in the pyrolyzer 106 of FIG. 1.

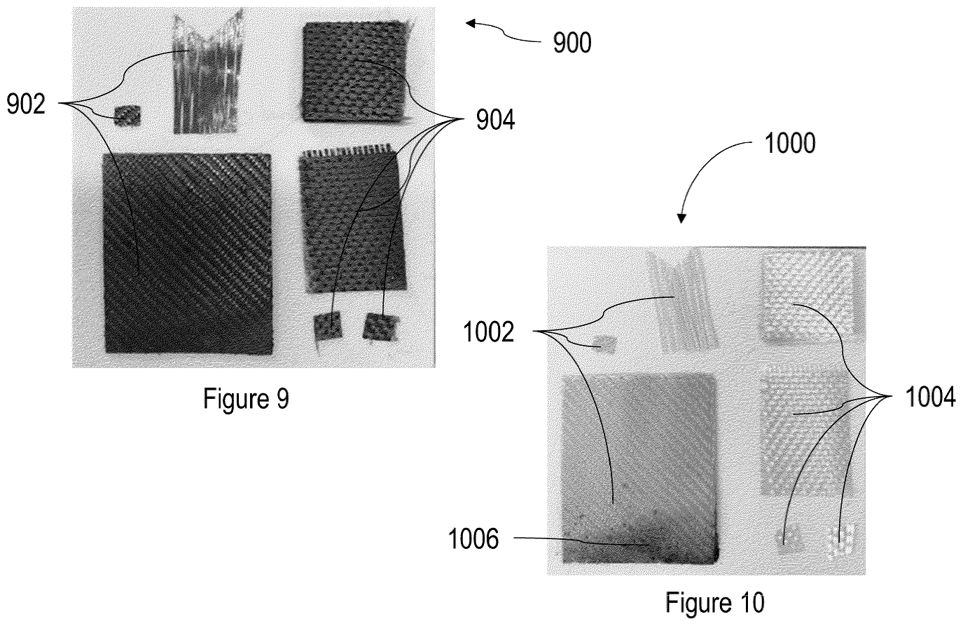

Referring now to FIG. 9 shown therein is a photograph of remnants 900 of the stock materials of FIGS. 3a and 3b that remain once pyrolysis is complete. The sandwich remnants 902 remain from the stock material in a sandwich structure 500 of FIG. 8A. The glass fiber/polymer remnants 904 remain from the glass fiber/polymer stock material 510 of FIG. 8B. The sandwich remnants 902 and glass fiber/polymer remnants 904 include glass fibers coated in carbon black.

Referring now to FIG. 10 shown therein is a photograph of the predominately glass fibers 1000 that remain once the remnants 900 of FIG. 9 are oxidized in a traditional oven. The oxidation burns off the carbon black 906 from the remnants 900 of FIG. 9 leaving essentially the glass fibers 900. Depending on the time and temperature of the oxidation, some carbon black 906 may remain on the glass fibers 900.

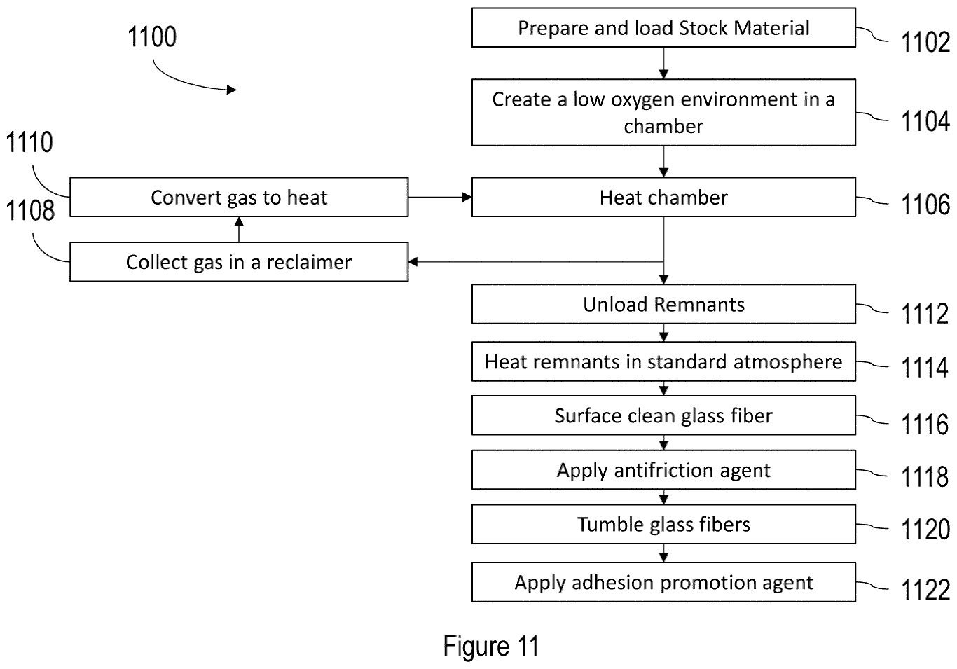

Referring now to FIG. 11, shown therein is a flow diagram of a method 1100 for reclaiming glass fibers, according to an embodiment. The method 1100 separates the glass fibers from a stock material and further prepares them for use in GFRPs. The method 1100 may be performed using the pyrolysis system 100 described with reference to FIG. 1-7B. The method 800 may process 500 kg of stock material per run. Each run may take 4 hours to process. Where operation consists of two eight hour shifts per day, a total of 4 runs amounting to 2000 kg of stock material may be processed per day.

At 1102, stock material, such as GRP, is prepared and loaded into a pyrolysis chamber. The pyrolysis chamber is of finite dimensions typically smaller than the vessel or structure that the stock material originates form. The stock material is harvested from the originating vessel or structure by cutting into stock material pieces that fit into the chamber. This may occur at the site the vessel or structure resides at or after transport to the pyrolysis system. Alternatively, the pyrolysis method may be deployed at a site containing the vessels or structures eliminating the need for further transport. Once cut, the stock material pieces are loaded into the chamber for pyrolysis.

If a flattening apparatus is to be used, the stock material is loaded into the apparatus. The apparatus may be loaded while inside the chamber or externally and loaded into the chamber as a unit.

At 1104, a low oxygen environment is created in a pyrolyzer chamber containing the stock material. The low oxygen environment prevents or reduces combustion of the stock material during pyrolysis causing elements of the stock material to vaporize without burning. The low oxygen environment may be created by establishing one or more environmental conditions including a vacuum or a neutral atmosphere. If the low oxygen environment is achieved via a vacuum a pressure of 10 mbar or less is maintained during pyrolysis. If the low oxygen environment is achieved via a neutral atmosphere, oxygen in the chamber is evacuated by the introduction a neutral gas, for example nitrogen, in the chamber to replace the oxygen.

At 1106, the chamber is heated to separate the stock material into a gas and a remnant (e.g., glass fibers). The operating temperatures of the heating typically range between 300° C. and 700° C. In an embodiment a nominal working operation temperature of 550° C. is maintained. The pyrolyzer may further heat the stock material for a process time of four hours. The process time may include a ramp up time of 40 minutes wherein the temperature of the stock material is gradually increased. The heating power may be calculated to be a minimum of 100 KW. At this heating power the temperature my raise 500 kg of GFPR from 400° C. to the nominal temperature in 40 minutes. The remaining three hours and 20 minutes comprise the treat time, as referred to above.

This heating vaporizes a portion of the stock material producing gases. The composition of the gases produced during vaporization is dependent on the temperature maintained during pyrolysis. Higher temperatures generally produce shorter and more desirable molecules. For example, higher temperatures will produce a higher ratio of non-condensable gases such as H₂, CH₄, C₂H₆, and C₂H₆ molecules and a lower ratio of CO, CO₂, C₃ containing molecules such as propane, and C₄ containing molecules such as benzene. Higher temperatures will also produce a higher ratio of gases condensable into a liquid phase such as benzene, toluene, styrene, and ethylbenzene. The higher temperature maintained during pyrolysis, however, the more power consumed. The power consumed therefore is balanced with the usefulness and desirability of the produced elements both as fuel for the power system and the market rate for other elements. Heating is continued until the gases cease to be produced at the selected temperature.

At 1108, the gas is collected and stored as fuel for the pyrolyzer. The method may further include condensing the gas to separate oils that condense into a liquid phase and non-condensable gases to be consumed independently.

At 1110 the gas is converted to heat for the pyrolyzer. The conversion may

be accomplished by using the gas as fuel, or part thereof, to generate electric power. The electric power may then power an electric heating element and/or an induction heating element. Alternatively, the conversion is accomplished by using the gas as fuel or part thereof for a gas burner. Alternatively, the conversion is accomplished by using the gas as fuel for another purpose which produces hot exhaust gas. The hot exhaust gas may be used to heat a heat exchanger. The conversion may also be accomplished by a combination of the above and/or other methods of generating heat from a gas.

At 1112, the remnants are removed from the pyrolyzer. Removing the remnants 1112 may occur after the remnants are heated in a standard atmosphere 1114 if the heating in a standard atmosphere 1114 is to be accomplished in the pyrolyzer.

At 1114, the remnants (e.g., carbon black coated glass fibers) are cleaned. The remnants are heated in an atmosphere environment at temperatures ranging between 300° C. and 700° C. The heating cleans the glass fibers of the carbon black by burning off any coatings. The remnants may be cleaned at a temperature of approximately 500° C. for 4 hours. The heating can occur in the chamber of the pyrolyzer or an external oven.

At 1116, the surface of the glass fibers may be manually cleaned to remove particulate matter not burned off. The manual cleaning may include one or more of immersing the glass fibers in an ultrasonic bath with solvents, oxidizing or reducing organic residues on the glass fibers with plasma such as O₂ plasma or hydrogen plasma, respectively, or through hydrolysis such as with boiling water or hydrogen peroxide.

At 1118, an antifriction agent is applied to the glass fibers. Friction can cause the fibers to wear while being handled. This wear degrades the quality of the fibers. The antifriction agent allows the fibers to slide along each other while being handled. The sliding mitigates the degradation of the glass fibers thereby maintain the quality of the glass fibers. The antifriction agent may be applied in vapor phase or as a chemical solution in a solvent. Applying the antifriction agent as a chemical solution may be preferred when large volumes of fibers are treated, as it is easier to implement. The antifriction agent may be one or more of Octadecyltrichlorosilane, teflon-terminated cholorsilane, or any silane that can be covalently attached to the surface of glass fibers and present antifriction properties.

At 1120, the glass fibers may be tumbled to randomize the orientation of the glass fibers. In some applications random glass fiber orientation provides desirable qualities in the composition of GFRPs. Tumbling the glass fibers achieves this orientation. In other applications, the existing orientation or one more easily achievable with the fibers originating in the existing orientation may be desirable. In these applications the tumbling may be omitted.

At 1122, an adhesion promoter is applied to the surface of the glass fibers. The glass fibers are reclaimed to form an ultimate GFRP which differs in one or more of form, composition, and quality of the GFRP stock material the glass fibers previous comprised. The adhesion promoter promotes adhesion of the resin to the glass fibers of the ultimate GFRP. The adhesion promoter can be applied in vapor phase or as a chemical solution in a solvent. Which adhesion promoter applied to the glass fibers depends on the resin of the ultimate GFRP. The adhesion promoter may be one or more of Epoxysilanes or aminosilanes, for examples amma-aminopropyltriethoxysilane, gamma-Aminopropylmethyldiethoxysilane, gamma-Aminopropyldimethylethoxysilane, and aminopropyltriethoxysilane may be applied for epoxy polymer resins. Metacrylsilanes, such as γ-methacryloxypropyltrimethoxysilane may be used for polyester and vynilester resins. In general silane coupling agents with appropriate molecular termination may be applied to the glass fibers to promote adhesion with polymer resins.

While the above description provides examples of one or more apparatus, methods, or systems, it will be appreciated that other apparatus, methods, or systems may be within the scope of the claims as interpreted by one of skill in the art.

1-35. (canceled)

36. A system for reclaiming glass fibers from a stock material, the system comprising:
a chamber for holding the stock material in a low oxygen environment; and
a pyrolyzer having a distributed heat source for heating the stock material;
wherein the distributed heat source uniformly heats the stock material to reduce the stock material to the glass fibers.

37. The system of claim 36, wherein the chamber further comprises a stock material flattening apparatus for flatting the stock material during heating.

38. The system of claim 37, wherein the stock material flattening apparatus includes the distributed heat source, and wherein the distributed heat source moves with the stock material flattening apparatus.

39. The system of claim 36, further comprising a reclaimer for collecting gas that is released when the stock material is heated.

40. The system of claim 39, further comprising a condenser for recovering oil from the gas.

41. The system of claim 39, further comprising a power system fueled by the gas, wherein the power system powers the pyrolyzer.

42. The system of claim 36, further comprising:
a plurality of chambers for pyrolyzing a plurality of stock materials; and
a vacuum control mechanism for controlling the low oxygen environment in one or more of the chambers independent of the low oxygen environment in another of the plurality of chambers.

43. The system of claim 36, further comprising:
a plurality of chambers for pyrolyzing a plurality of stock materials; and
a temperature control mechanism for controlling the temperature in one or more of the chambers independent of the temperature in another of the plurality of chambers.

44. The system of claim 36, further comprising a rack system configured to load and unload the stock materials into and out of the pyrolyzer.

45. The system of claim 44, wherein the rack system includes a plurality of racks.

46. The system of claim 44, wherein the rack system further comprises a rack frame configured to support at least one rack and wherein the rack is detachable from the rack frame.

47. The system of claim 44, wherein the pyrolyzer further comprises at least one door and wherein the rack system is at least partially supported by an internal surface of the door during one or more of loading and unloading.

48. The system of claim 36, wherein the pyrolyzer further comprises an explosion hatch wherein the explosion hatch is configured to be the weak link in the event of an explosion.

49. The system of claim 36, further comprising a control system cabinet configured to provide a radio control based on at least one information from at least one sensor of the pyrolyzer.

50. A method for reclaiming glass fibers a stock material, the method comprising:
holding the stock material in a low oxygen environment;
uniformly heating the stock material in the low oxygen environment; and
reducing the stock material to the glass fibers.

51. The method of claim 50, comprising:
loading a rack system with the stock material;
providing the stock material to the low oxygen environment with the rack system by moving at least part of the rack system into the low oxygen environment of a pyrolyzer;
removing the stock material from the low oxygen environment with the rack system by removing at least part of the rack system from the low oxygen environment of the pyrolyzer.

52. The method of claim 50, further comprising flattening the stock material during Heating.

53. The method of claim 50, further comprising heating the glass fibers in an atmosphere environment and removing a carbon coating from the glass fibers.

54. The method of claim 51, wherein the rack system further comprises a rack frame configured to support at least one rack and wherein the rack is detachable from the rack frame and wherein loading the rack system further comprises loading the rack with stock material and attaching the rack to the rack frame.

55. The method of claim 54, wherein the rack is one or more of charged and discharged outside the low oxygen environment.
